(19) United States
(12) Patent Application Publication
(10) Pub. No.: US 2009/0152228 A1
(43) Pub. Date: Jun. 18, 2009

(54) Combination nipple and cap

(76) Inventor: Zeno McCaskill, Chicago, IL (US)

Correspondence Address: JAMES RAY & ASSOCIATES, 2640 PITCAIRN ROAD, MONROEVILLE, PA, 15146, US

(21) Appl. No.: 12/002,132

(22) Filed: Dec. 14, 2007

(51) Int. Cl. A61J 9/08

(52) U.S. Cl. 215/11.6

(57) ABSTRACT

A combination nipple and cap for placement on at least one of bottles and cans having a pour opening disposed on one end thereof. The cap has a predetermined size and is manufactured from a first predetermined material. The nipple is manufactured from a second predetermined material and is operably connected to the cap. A securing means is operably connected to the cap to secure the cap to such pour opening.

### FIELD OF THE INVENTION

The present invention relates, in general, to caps and, more particularly, this invention relates to nipples and caps.

### BACKGROUND OF THE INVENTION

Prior to the conception and development of the present invention, nipples, as are generally well known in the prior art, have been used to cover baby bottles and still allow a baby to drink from such bottle. Cap style lids have been used to cover water bottles and the like and children and adults remove such lids to drink from such bottles. However, no combination of nipples and caps exist for placement on conventional bottles and cans for children and adults to enjoy.

Specifically of interest to the present invention are the following: Stephan, U.S. Pat. No. 6,851,565, discloses an annular adapter for a standard beverage bottle, such as a plastic water bottle, to accommodate the internal threads of a baby's annular nipple cap, which has a nipple inserted therein. Inside the annular adapter is a seal to prevent leakage. Liquid flows through the central opening of the annular adapter. The nipple is inserted and the seal engages the bottle. The annular adapter is screwed over a conventional threaded exterior neck of a standard beverage bottle, such as a water bottle.

Blanding, U.S. Pat. No. 6,666,345, discloses a molded baby bottle cap of a soft rubber and a molded water bottle cap of a hard plastic, the baby bottle cap providing an annular portion extending axially within the baby bottle cap. Plural molded circular ribs are engaged within the water bottle cap thereby interlocking the two caps. The apparatus is thus engagable with a baby bottle in a typical manner using a threaded compression ring, or with a water bottle using threads molded into the water bottle cap.

Nohren, et al, U.S. Pat. No. 6,165,362 discloses a filter assembly, particularly for use with a plastic bottle having an open neck with an inside diameter of about 50 mm or less (e.g. about 25 mm), including a tube of filtering material connected to one surface of a cap while a valve extends from an opposite surface of the cap. The valve may be a reciprocating valve, a baby bottle nipple, or a spray device.

Conrad, U.S. Pat. No. 5,112,628, discloses a bottle feeder including a tamper evident overcap, which captures a nipple and hold-down cap and has a pop-up indicator to insure the integrity of the bottle is described. Upon removal of the overcap the tamper evident band remains on the bottle and the pop-up indicator indicates the feeder has been opened. The nipple and hold-down cap can be withdrawn from the overcap and placed on the bottle for use.

Carmen, et al, U.S. Patent Application No. 20060006128, discloses a cap capable to be screwed in with nipple and cover cap which allows that refreshment or water bottles which have a conventional screw thread system can be used as baby's bottles.

### SUMMARY OF THE INVENTION

The present invention provides a combination nipple and cap for placement on at least one of a bottle and a can having a pour opening disposed on one end thereof. The cap has a predetermined size and is manufactured from a first predetermined material. A nipple, manufactured from a second predetermined material, is operably connected to such cap. A securing means is operably connected to such cap to secure such cap to such pour opening.

### OBJECTS OF THE INVENTION

It is, therefore, one of the primary objects of the present invention to provide a unique cap for use in drinking out of bottles and cans.

Another object of the present invention is to provide a novelty item for use by children and adults to amuse themselves and others and gain attention.

Still another object of the present invention is to provide a cap or top for bottles and cans that will reduce the amount of spills by a user.

Yet another object of the present invention is to provide an interesting and unique accessory for bottles and cans that can be sold by vendors to customers at an inexpensive price.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of a combination nipple and cap secured on a beverage bottle having a pour opening disposed on one end thereof.

FIG. 2 is a partial perspective view of a combination nipple and cap secured on a beverage can having a pour opening disposed on one end thereof.

FIG. 3 is a partial perspective view of a combination nipple and cap securable to a beverage bottle having a pour opening disposed on one end thereof by means of threading such cap to the bottle.

FIG. 4 is a partial perspective view of a combination nipple and cap securable to a beverage bottle having a pour opening disposed on one end thereof by means of elastomeric material gripping such bottle.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

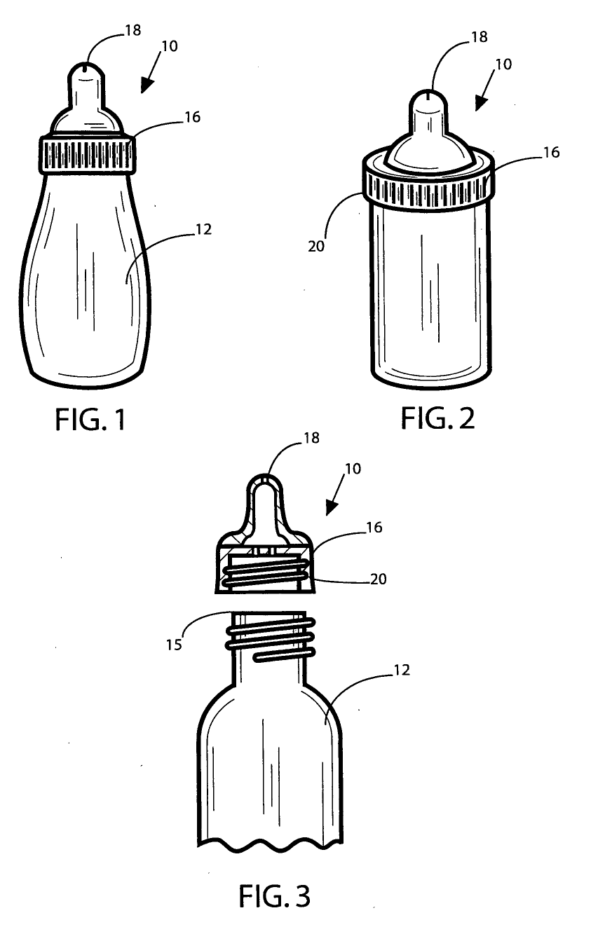

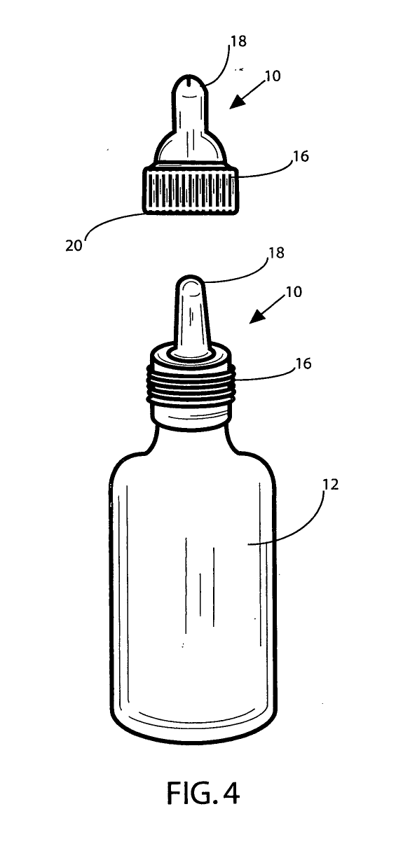

Reference is now made, more particularly, to FIGS. 1-4.

A combination nipple and cap, generally designated 10, for placement on at least one of a bottle 12 and a can 14 having a pour opening 15 disposed on one end thereof is provided.

The cap 16 has a predetermined size and is manufactured from a first predetermined material. It is presently preferred that the cap is formed in a variety of colors. It is further presently preferred that such first predetermined material is plastic.

A nipple 18, manufactured from a second predetermined material, is operably connected to the cap 16. It is presently preferred that the nipple 18 is formed in a variety of colors. It is further presently preferred that such second predetermined material is selected from an elastomeric material. It is presently preferred that the elastomeric material is selected from the group consisting of rubber and silicone. It is presently most preferred that the elastomeric material is rubber.

A securing means 20 is operably connected to the cap 16 for securing the cap 16 to such pour opening 15. It is presently preferred that such cap 16 is at least one of threaded and elastically deformed for securing such cap 16 to such bottle 12.

In the presently preferred embodiment of the invention, the cap 16 threads securely to such bottle 12.

In another embodiment of the invention, the cap 16 is disposed over one end of such can 14 in a fluid type manner.

In yet another embodiment of the invention, the nipple 18 and cap 16 are substantially identical in color.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A combination nipple and cap for placement on at least one of a bottle and a can having a pour opening disposed on one end thereof comprising;
a. a cap having a predetermined size and manufactured from a first predetermined material;
b. a nipple, manufactured from a second predetermined material, operably connected to said cap; and
c. a securing means operably connected to said cap for securing said cap to such pour opening.

2. A combination nipple and cap according to claim 1 wherein said first predetermined material is plastic.

3. A combination nipple and cap according to claim 1 wherein said second predetermined material is an elastomeric material.

4. A combination nipple and cap according to claim 3 wherein said elastomeric material is selected from the group consisting of rubber and silicone.

5. A combination nipple and cap according to claim 4 wherein said elastomeric material is rubber.

6. A combination nipple and cap according to claim 1 wherein said cap is at least one of threaded and elastically deformed for securing said cap to such bottle.

7. A combination nipple and cap according to claim 1 wherein said cap is threaded to such bottle.

8. A combination nipple and cap according to claim 1 wherein said cap is elastically deformed for securing said cap to such bottle.

9. A combination nipple and cap according to claim 3 wherein said cap is disposed over one end of such can in a fluid type manner.

10. A combination nipple and cap according to claim 1 wherein said nipple is formed in a variety of colors.

11. A combination nipple and cap according to claim 1 wherein said cap is formed in a variety of colors.

12. A combination nipple and cap according to claim 1 wherein said nipple and said cap are substantially identical in color.
